(19) United States
(12) Patent Application Publication
(10) Pub. No.: US 2016/0020670 A1
(43) Pub. Date: Jan. 21, 2016

(54) ENERGY CONVERSION APPARATUS AND METHOD

(71) Applicant: IPH + Limited, Preston (GB)

(72) Inventor: William A. Green, Midland, TX (US)

(21) Appl. No.: 14/331,910

(22) Filed: Jul. 15, 2014

(51) Int. Cl. H02K 7/18

(52) U.S. Cl. CPC H02K 7/1846

(57) ABSTRACT

An energy conversion apparatus and method is disclosed. The energy conversion apparatus includes an input shaft, coupleable to a prime mover, by which mechanical energy may be supplied to the apparatus to thereby cause rotation of the input shaft and an electrical generator, operable to output electrical energy from the apparatus in response to rotation of a generator rotor. The electrical generator is coupled to the input shaft and mounted offset therefrom for body rotation with the input shaft, eccentric to the axis of rotation of the input shaft. The generator rotor is coupled to an eccentric mass element, arranged such that body rotation of the generator causes rotation of the generator rotor by action of the eccentric mass element, under gravity. Suitably, the energy conversion apparatus includes two or more electrical generators as described above.

### BACKGROUND OF THE INVENTION

Example embodiments relate to energy conversion apparatus and methods, in particular energy conversion apparatus and methods in which mechanical energy is converted to electrical energy.

The counter electromotive force induced in an electrical generator in use results in a counter torque, that must be exceeded by the prime mover coupled to the electrical generator. In particular, the cogging counter torque of the electrical generator results in undesirable pulsations in the electrical output of the electrical generator, especially at low rotational speeds of the prime mover. The frequency and amplitude of the undesirable pulsations in the electrical output of the electrical generator depend on the number of poles on the generator rotor and the number of teeth on the generator stator. Increasing the number of poles on the generator rotor and increasing the number of teeth on the generator stator reduce the amplitude but increases the frequency of the undesirable pulsations in the electrical output of the electrical generator. Gearing of the output of the prime mover is additionally required to increase the rotational speed of the input to the electrical generator to minimize the undesirable pulsations in the electrical output of the electrical generator.

Where there is significant variation in the rotational speed of the prime mover (for example, where the prime mover is a wind turbine), such gearing of the output of the prime mover will not minimize the undesirable pulsations in the electrical output of the electrical generator over the full operational range of rotational speeds of the prime mover. Further, since the gearing of the output of the prime mover and the generator are matched to the prime mover, these must be selected specifically for the prime mover. Unbalanced static forces on the prime mover are undesirable because they increase the load on the prime mover, whereas unbalanced dynamic forces on the prime mover are undesirable because they reduce the efficiency of the conversion of mechanical energy to electrical energy and create vibration in the prime mover.

Example embodiments of the present invention aim to address one or more problems associated with the prior art, for example those problems set out above.

### BRIEF SUMMARY OF THE INVENTION

In one example embodiment, the present invention provides an energy conversion apparatus having an input shaft, coupleable to a prime mover, by which mechanical energy may be supplied to the apparatus to thereby cause rotation of the input shaft. The apparatus further including an electrical generator, operable to output electrical energy from the apparatus in response to rotation of a generator rotor. The electrical generator is coupled to the input shaft and mounted offset therefrom for body rotation with the input shaft, eccentric to the axis of rotation of the input shaft. The generator rotor is coupled to an eccentric mass element, arranged such that body rotation of the generator causes rotation of the generator rotor by action of the eccentric mass element, under gravity.

Suitably, the energy conversion apparatus includes a plurality of electrical generators for example two or more electrical generators. Suitably, the energy conversion apparatus includes a plurality of eccentric mass elements for example two or more eccentric mass elements, such as to provide one eccentric mass element for generators in the plurality of generators for example. Suitably, the energy conversion apparatus includes a plurality of electrical generators with a plurality of eccentric mass elements coupled thereto, wherein an eccentric mass element is coupled to an electrical generator for example with one eccentric mass element coupled to each electrical generator.

Suitably, the plurality of electrical generators are arranged to be statically balanced about the input shaft in use so as to minimize the unbalanced static forces on the energy conversion apparatus and on the prime mover. Suitably, the plurality of electrical generators are arranged to provide a dynamic balance about the input shaft in use so as to minimize the unbalanced dynamic forces on the energy conversion apparatus and on the prime mover in use. In this way the efficiency of the energy conversion apparatus in use may be improved, and undesirable vibration in the energy conversion apparatus and prime mover in use may be reduced.

Suitably, the axis of rotation of the generator rotor and the axis of rotation of the input shaft are parallel. Suitably, the axis of rotation of the generator rotor and the axis of rotation of the input shaft are tilted relatively. Suitably, the axis of rotation of the generator rotor and the axis of rotation of the input shaft are non-orthogonal.

Suitably, the axis of rotation of the generator rotor is horizontal.

Suitably, the electrical generator includes a generator stator.

Suitably, the generator rotor includes a plurality of poles for example two, four, six or more poles. Suitably, the generator stator includes a plurality of teeth for example three, five, seven or more teeth. Suitably, the electrical output of the electrical generator has an angular periodicity that is a function of the number of poles and the number of teeth.

Suitably, the energy conversion apparatus includes a plurality of electrical generators arranged such that the generator stators of the plurality of electrical generators are not rotationally aligned with one another. By providing electrical generators that are rotationally offset from one another, for example at a rotationally offset angle that is a fraction corresponding to the number of generators of the angular periodicity of the electrical generator, pulsations in the electrical output of the energy conversion apparatus made by combining the electrical output of the generators may be reduced. Suitably, the fraction may be proportional to, for example equal to the reciprocal of the number of generators.

Suitably, the plurality of electrical generators is arranged mounted offset equally from the input shaft, for example two electrical generators are arranged mounted offset equally from the input shaft such that the two electrical generators are on the same locus of rotation about the axis of rotation of the input shaft. Suitably, the plurality of electrical generators is arranged mounted offset non-equally from the input shaft, for example two electrical generators are arranged mounted offset non-equally from the input shaft such that the two electrical generators are on different loci of rotation about the axis of rotation of the input shaft.

Suitably, the plurality of generator rotors is aligned mutually parallel, for example two generator rotors are aligned mutually parallel. Suitably, the plurality of generator rotors is aligned mutually non-parallel, for example two generator rotors are aligned mutually non-parallel.

Suitably, the plurality of electrical generators is arranged with rotational symmetry about the input shaft.

Suitably, the generator rotor is coupled to the input shaft and mounted offset therefrom. Suitably, the electrical generator is coupled to an eccentric mass element, arranged such that body rotation of the generator rotor causes rotation of the electrical generator by action of the eccentric mass element, under gravity.

Suitably, the electrical generator is a dynamo. Suitably, the electrical generator is an alternator. Suitably, the electrical generator is an induction generator. Suitably, the electrical generator is an asynchronous singly fed generator. Suitably, the electrical generator is a doubly fed generator. Suitably, the electrical generator is a brushless wound-rotor doubly fed generator.

Suitably, the plurality of electrical generators is similar, for example two electrical generators are similar. Suitably, the plurality of electrical generators is dissimilar, for example two electrical generators are dissimilar. Suitably, the plurality of eccentric mass elements is similar, for example two eccentric mass elements are similar. Suitably, the plurality of eccentric mass elements is dissimilar, for example two eccentric mass elements are dissimilar.

Suitably, electrical energy is transmitted from the electrical generator via slip rings on the input shaft.

Suitably, the prime mover is a wind turbine. Suitably, the prime mover is a water turbine. Suitably, the prime mover is an engine. Suitably, the prime mover is an internal combustion engine. Suitably, the prime mover is an electric motor.

In another example embodiment, the present invention provides a power station including an energy conversion apparatus as set out above with a prime mover coupled thereto.

In one example embodiment, the present invention provides a method of energy conversion performed using an energy conversion apparatus including an input shaft, coupleable to a prime mover, by which mechanical energy may be supplied to the apparatus to thereby cause rotation of the input shaft; and an electrical generator, operable to output electrical energy from the apparatus in response to rotation of a generator rotor. The electrical generator is coupled to the input shaft and mounted offset therefrom for body rotation with the input shaft, eccentric to the axis of rotation of the input shaft, with the axis of rotation of the input shaft and the axis of rotation of the generator rotor aligned generally parallel with one another. The generator rotor is coupled to an eccentric mass element. The method includes rotating the input shaft to cause body rotation of the generator, and thereby rotation of the generator rotor by action of the eccentric mass element under gravity.

Suitably, the plurality of electrical generators with the plurality of eccentric mass elements coupled thereto are statically balanced about the input shaft in use. Suitably, the plurality of electrical generators with the plurality of eccentric mass elements coupled thereto are dynamically balanced about the input shaft in use.

Suitably, the eccentric mass element is arranged such that the torque due to the eccentric mass element about the axis of rotation of the generator rotor balances the opposing torque due to the electrical generator in use as the input shaft is rotated. Suitably, the eccentric mass element is arranged such that the torque due to the eccentric mass element about the axis of rotation of the generator rotor does not balance the opposing torque due to the electrical generator in use as the input shaft is rotated.

Suitably, the eccentric mass element is arranged such that the centripetal acceleration of the eccentric mass element is less than the acceleration due to gravity in use such that the centre of gravity of the eccentric mass element remains below the axis of rotation of the generator rotor in use.

Suitably, the method includes continuous rotation of the input shaft in use. Suitably, the method includes bidirectional rotation of the input shaft in use.

In other example embodiments the present invention provides methods of energy conversion, including use of the energy conversion apparatus as set out above.

### BRIEF DESCRIPTION OF THE INVENTION

For a better understanding of the invention, and to show how embodiments of the same may be carried into effect, reference will now be made, by way of example, to the accompanying diagrammatic drawings in which:

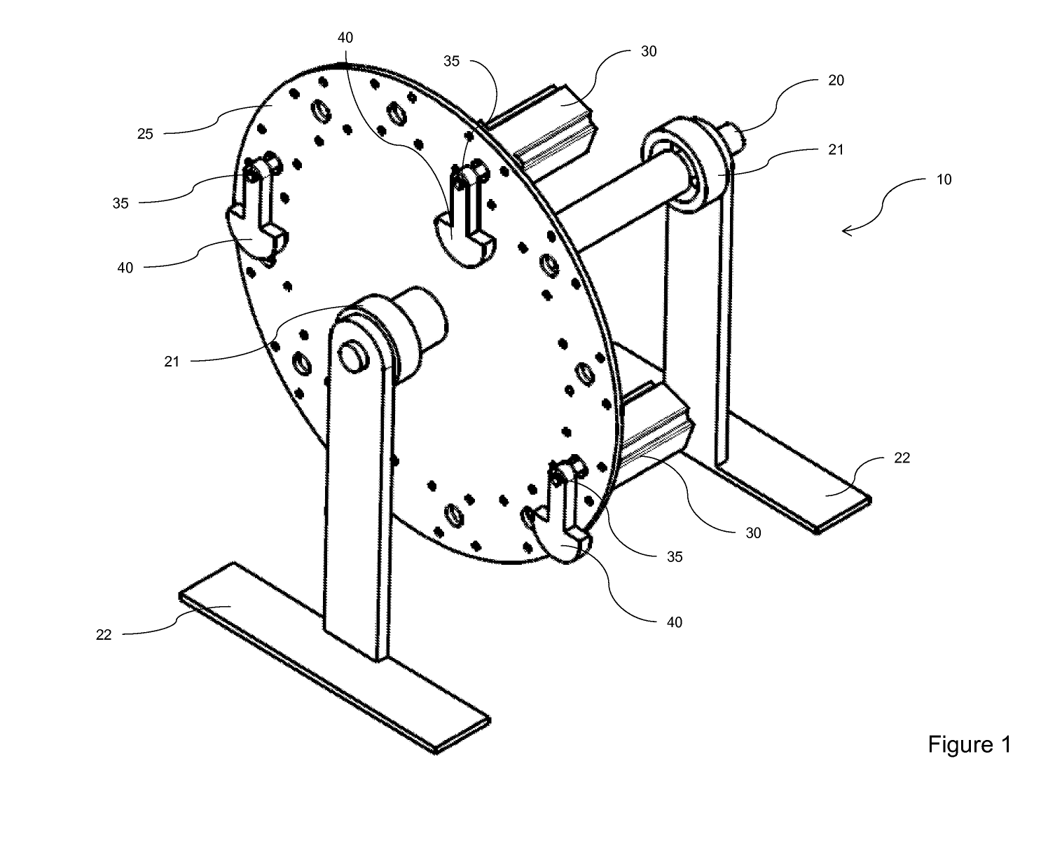

FIG. 1 shows a perspective view of an energy conversion apparatus according to an example embodiment;

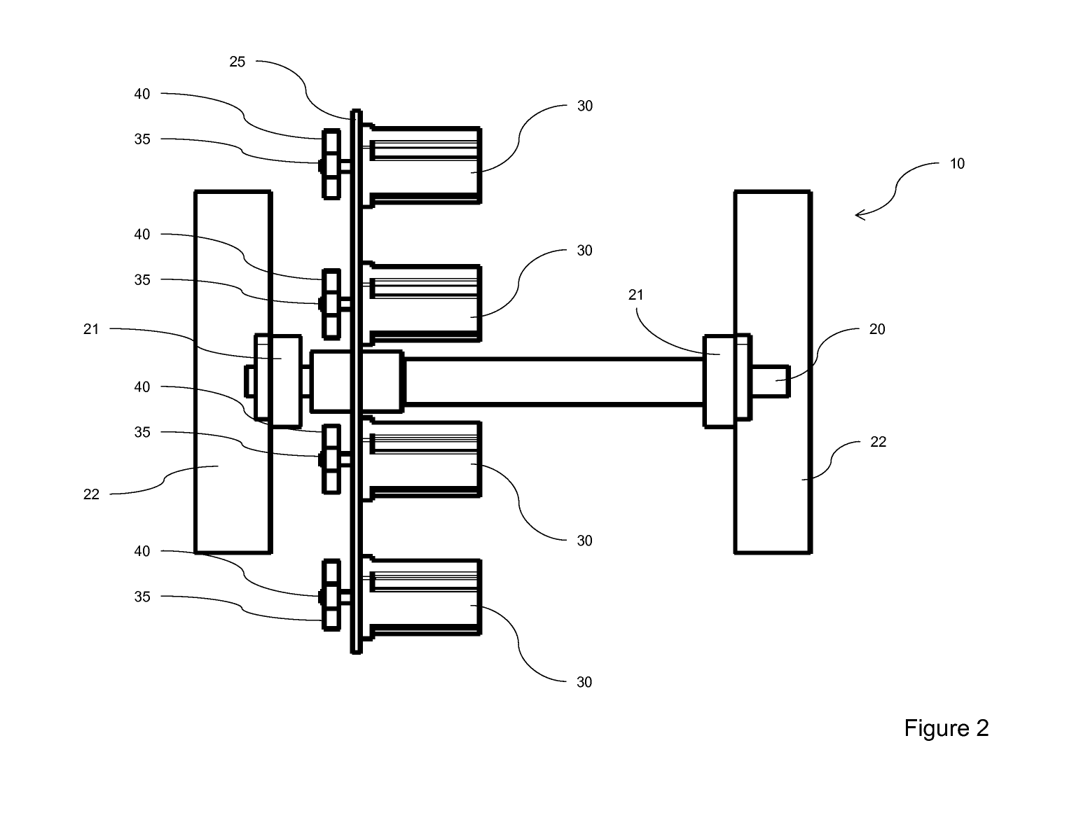

FIG. 2 shows a plan view of the energy conversion apparatus of FIG. 1;

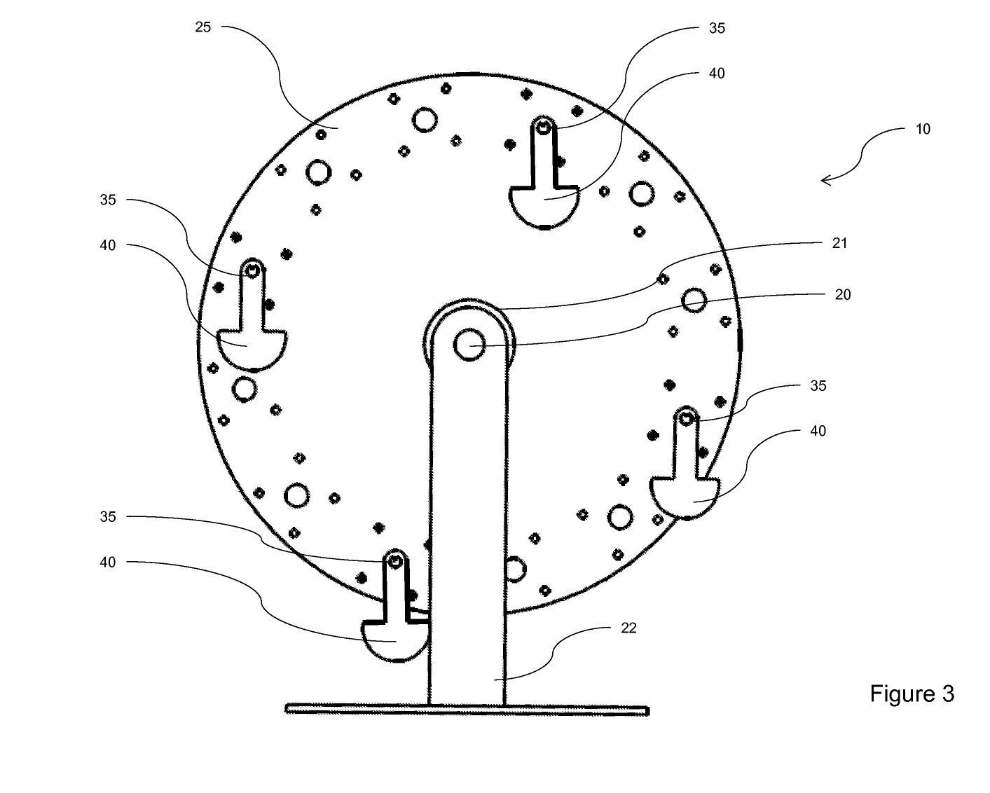

FIG. 3 shows a front elevation of the energy conversion apparatus of FIG. 1;

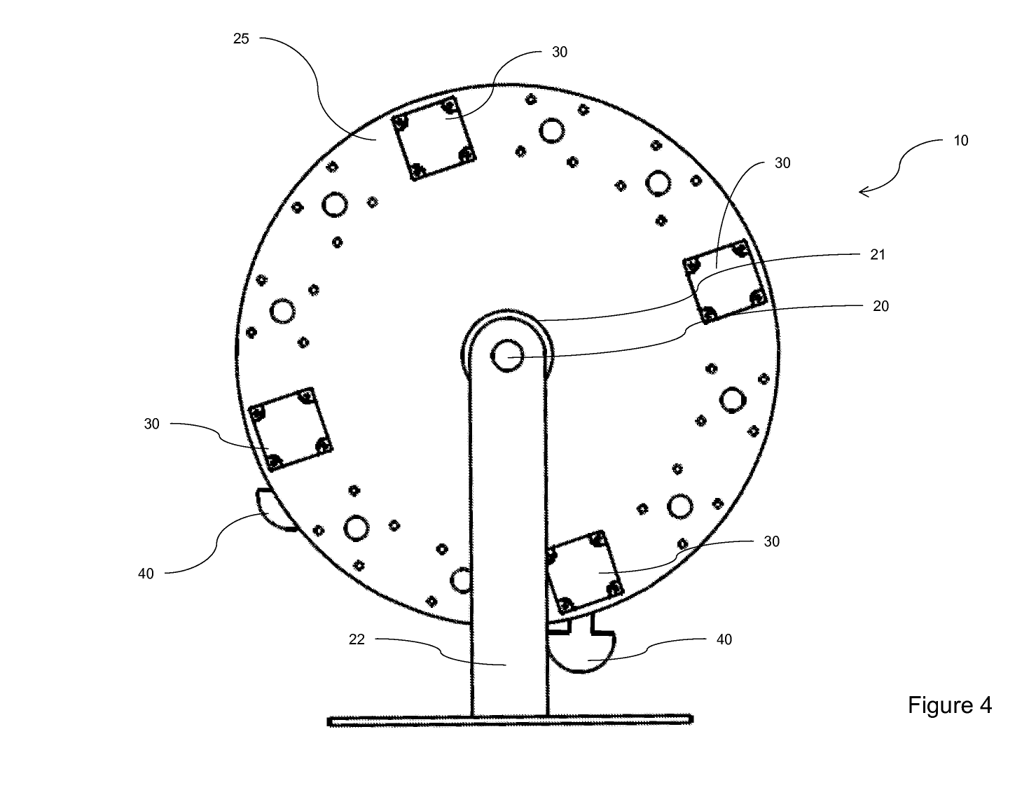

FIG. 4 shows an end elevation of the energy conversion apparatus of FIG. 1;

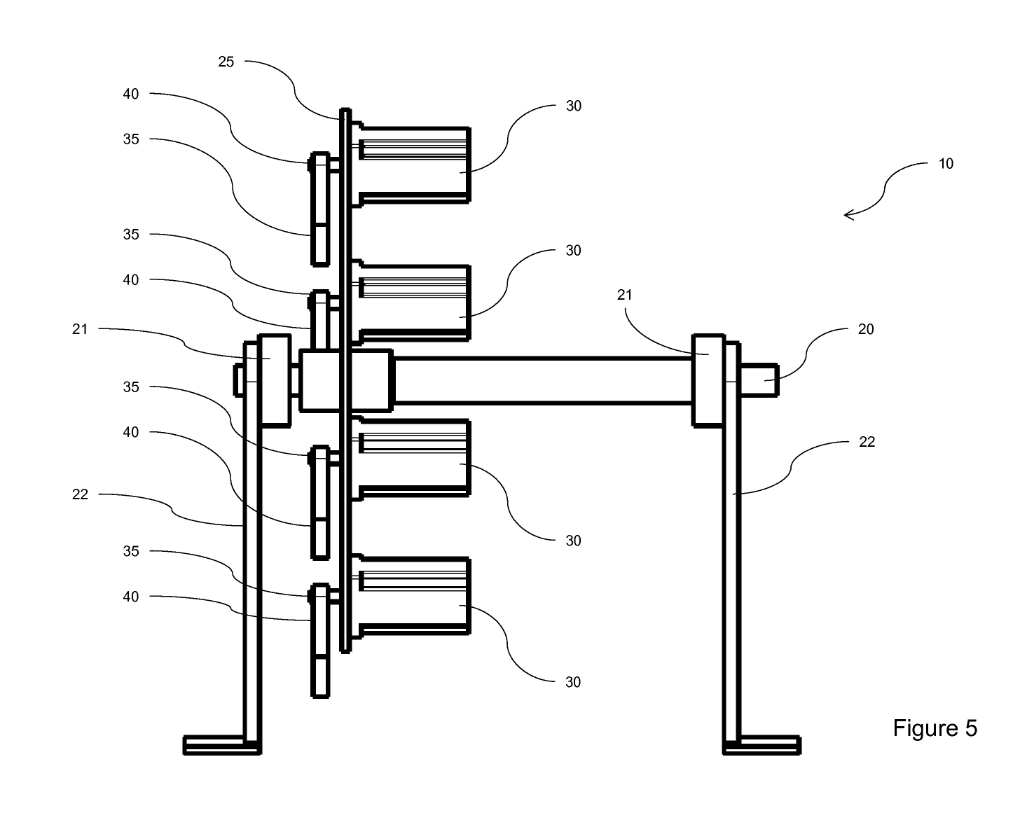

FIG. 5 shows a side elevation of the energy conversion apparatus of FIG. 1; and

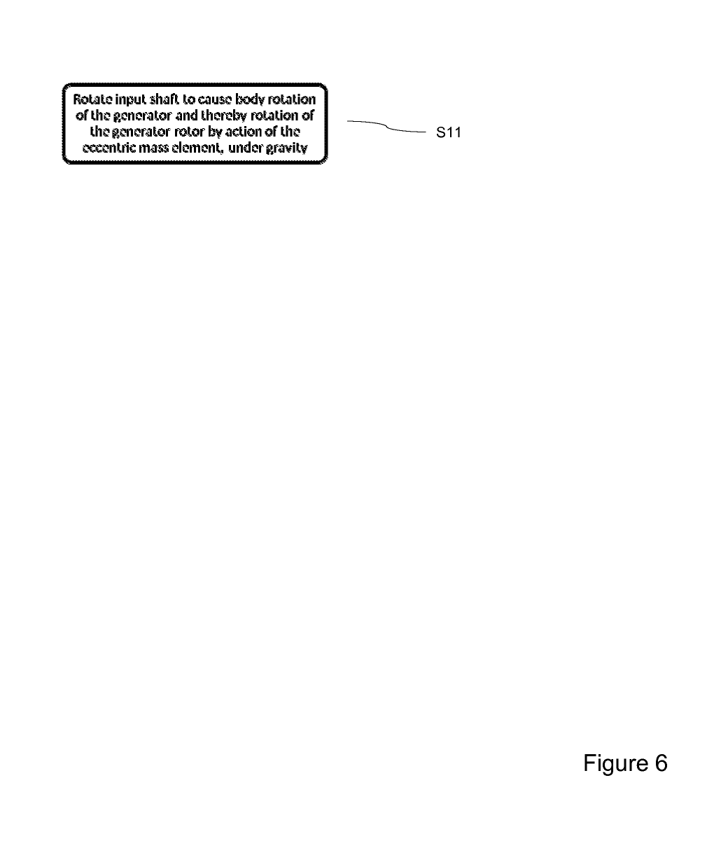

FIG. 6 shows a method of operating an energy conversion apparatus according to an example embodiment.

### DETAILED DESCRIPTION OF THE INVENTION

Referring now to FIGS. 1 to 5 there is shown an energy conversion apparatus 10 in accordance with an example embodiment. The energy conversion apparatus 10 includes an input shaft 20, coupled to a prime mover (not shown), for example a wind turbine, and arranged, when driven, to cause rotation of the input shaft 20 mounted in bearings 21 mounted on a frame 22. A plurality of electrical generators 30, in this example embodiment four electrical generators 30, are mounted offset from the input shaft 20 on a flywheel 25 and arranged, when driven, for body rotation with the input shaft 20, eccentric to the axis of rotation of the input shaft 20.

Each of the electrical generators 30 include a generator rotor 35 arranged, when driven, to output electrical energy from the electrical generator 30 in response to rotation of the generator rotor 30 about the axis of rotation of the generator rotor 30.

In use, the generator rotors 30 are each coupled to an eccentric mass element 40. Body rotation of the electrical generator 30 causes the rotation of the generator rotor 30 about the axis of rotation of the generator rotor 30 by action of the eccentric mass element 40, under gravity.

Suitably, the density of the eccentric mass elements is such that the eccentric mass elements have a large mass relative to their size.

The eccentric mass elements 40 coupled to the electrical generators 30 mounted eccentric to the input shaft 20 in use balance the cogging counter torque of the electrical generators 30 and thereby minimise the undesirable pulsations in the electrical output of the electrical generators 30. Gearing of the output of the prime mover, so as to increase the rotational speed of the input shaft 20, is not required since the balancing of the cogging counter torque of the electrical generators 30 of the present invention is effective at low rotational speeds of the input shaft 20. Where there is significant variation in the rotational speed of the prime mover (for example, where the prime mover is a wind turbine), the balancing of the cogging counter torque of the electrical generators 30 of the present invention is effective in minimising the undesirable pulsations in the electrical output of the electrical generators 30 over a range of rotational speeds of the prime mover, including low rotational speeds of the prime mover.

The arrangement of a plurality of electrical generators 30 mounted as described further minimizes the undesirable pulsations in the electrical output of the energy conversion apparatus 10. Particularly, the plurality of electrical generators 30 are mounted rotationally offset from one another, at a rotationally offset angle that is ¼ of the angular periodicity of pulsations in the electrical output of each electrical generator 30. In this example embodiment the rotational offset angle is ¼ of the angular periodicity of pulsations in electrical output of each generator because ¼ is the reciprocal of the number of electrical generators. In this way the pulsations in the electrical output of the energy conversion apparatus that come from the combined output of the plurality of electrical generators 30 are reduced in amplitude.

The electrical energy output from the electrical generators 30 is conducted via, for example, slip rings on the input shaft 20 and hence to an electrical load (not shown).

In the example embodiment of FIGS. 1 to 5, a plurality of electrical generators 30 and generator rotors 35 and eccentric mass elements 40 are illustrated, but it is to be understood that this is for illustration only, and other example embodiments may be provided with a single electrical generator 30 and a single generator rotor 35 and a single eccentric mass element 40. Likewise, the solid flywheel 25 of FIGS. 1 to 5 may in alternative embodiments be replaced by a crank or plurality of cranks coupled to the input shaft 20.

In the example embodiment of FIGS. 1 to 5, electrical generators 30 are illustrated arranged with rotational symmetry about the input shaft 20, but it is to be understood that this is for illustration only, and other example embodiments may be provided with electrical generators 30 arranged with rotational asymmetry about the input shaft 20, and furthermore in other example embodiments the electrical generators 30 may be provided mounted on both sides of the flywheel 25.

Referring now to FIG. 6 there is shown a method of operating an energy conversion apparatus according to an example embodiment. At S11, the input shaft 20 is rotated to cause body rotation of the electrical generators 30 and thereby rotation of the generator rotors 35 by action of the eccentric mass elements 40, under gravity.

As set out above, an energy conversion apparatus according to the example embodiment can provide conversion of mechanical energy to electrical energy. Providing the eccentric mass elements overcomes the counterforce in the generators as the generators are rotated about the input shaft.

Although a preferred embodiment has been shown and described, it will be appreciated by those skilled in the art that various changes and modifications might be made without departing from the scope of the invention, and as may also be defined in any appended claims.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

I Claim:

1. An energy conversion apparatus, comprising:
an input shaft, coupleable to a prime mover, by which mechanical energy may be supplied to the apparatus to thereby cause rotation of the input shaft;
an electrical generator, operable to output electrical energy from the apparatus in response to rotation of a generator rotor, wherein the electrical generator is coupled to the input shaft and mounted offset therefrom for body rotation with the input shaft, eccentric to the axis of rotation of the input shaft;
wherein the generator rotor is coupled to an eccentric mass element, arranged such that body rotation of the generator causes rotation of the generator rotor by action of the eccentric mass element, under gravity.

2. The energy conversion apparatus according to claim 1, wherein the axis of rotation of the generator rotor and the axis of rotation of the input shaft are parallel.

3. The energy conversion apparatus according claim 1, wherein the axis of rotation of the generator rotor and the axis of rotation of the input shaft are tilted relatively.

4. The energy conversion apparatus according to claim 1, wherein the energy conversion apparatus includes a plurality of electrical generators with a plurality of eccentric mass elements coupled thereto wherein an eccentric mass element is coupled to an electrical generator.

5. The energy conversion apparatus according to claim 1, wherein the energy conversion apparatus includes a plurality of electrical generators arranged mounted offset equally from the input shaft.

6. The energy conversion apparatus according to claim 5, wherein the plurality of electrical generators is arranged with rotational symmetry about the input shaft.

7. The energy conversion apparatus according to claim 1, wherein the electrical generator comprises one selected from a group comprising: a dynamo, an alternator, an induction generator, an asynchronous singly fed generator, a doubly fed generator and a brushless wound-rotor doubly fed generator.

8. The energy conversion apparatus according to claim 1, wherein the prime mover comprises one selected from a group comprising: a wind turbine, a water turbine, an internal combustion engine, an external combustion engine and an electric motor.

9. A method of energy conversion performed using an energy conversion apparatus comprising:
an input shaft, coupleable to a prime mover, by which mechanical energy may be supplied to the apparatus to thereby cause rotation of the input shaft;
an electrical generator, operable to output electrical energy from the apparatus in response to rotation of a generator rotor, wherein the electrical generator is coupled to the input shaft and mounted offset therefrom for body rotation with the input shaft, eccentric to the axis of rotation of the input shaft,;
wherein the generator rotor is coupled to an eccentric mass element, the method comprising steps:
rotating the input shaft to cause body rotation of the generator and thereby rotation of the generator rotor by action of the eccentric mass element, under gravity.

10. The method of energy conversion according to claim 9, wherein the eccentric mass element is arranged such that the torque due to the eccentric mass element about the axis of rotation of the generator rotor balances the opposing torque due to the electrical generator as the input shaft is rotated.

11. The method of energy conversion according to claim 9, wherein the eccentric mass element is arranged such that the centripetal acceleration of the eccentric mass element is less than the acceleration due to gravity such that the centre of gravity of the eccentric mass element remains below the axis of rotation of the generator rotor.

12. The method of energy conversion according to claim 9, wherein the rotation of the input shaft is continuous in use.

13. The method of energy conversion according to claim 9, wherein the energy conversion apparatus comprises a plurality of electrical generators with a plurality of eccentric mass elements coupled thereto wherein an eccentric mass element is coupled to an electrical generator.

14. The method of energy conversion according to claim 13, wherein the plurality of electrical generators with the plurality of eccentric mass elements coupled thereto are dynamically balanced about the input shaft.
